(19) United States
(12) Patent Application Publication
(10) Pub. No.: US 2007/0106656 A1
(43) Pub. Date: May 10, 2007

(54) Apparatus and method for performing profile based collaborative filtering

(75) Inventor: Srinivas Gutta, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/556,252

(22) PCT Filed: May 6, 2004
(86) PCT No.: PCT/IB04/01514

§ 371 Date: Nov. 10, 2005

Related U.S. Application Data
(60) Provisional application No. 60/469,676, filed on May 12, 2003.

(51) Int. Cl. G06F 17/30

(52) U.S. Cl. 707/5

(57) ABSTRACT

Methods and apparatus are disclosed to various embodiments for recommending items (150) to an advisee such as television program recommendations, based on other user's viewing preferences (140) or profiles (160). In contrast to the state of the art, the other user's have at least one demographic in common with the advise, such as age, income or gender for example or combinations thereof. According to one aspect of the invention, recommendations may be generated before a viewing or purchase history of the advisee is available. According to one embodiment, a method for recommending items includes the acts of receiving a recommendation request from an advisee for a recommendation of said items; filtering a general population of users to identify a sub-population of users who share at least one demographic in common with said advisee; computing a degree of closeness measure between preference data associated with each user in the sub-population and one of preference (140) and profile (160) data associated with said advisee; selecting the preference data associating with N users from said sub-population having the lowest computed degree of closeness measure with the advisee, where N is a positive integer value, equal to or greater than 1; using the selected preference data to recommend said items to the advisee.

The present invention relates generally to methods and apparatus for recommending items of interest to users, and more particularly, to a system and method for recommending items to a user based on the profiles of other users.

Recommender systems predict the preferences of users based on attributes known about the user or a past history of preferences or consumption by the user. For example, a recommender system may predict that a user will like the movie “Star Wars” because he previously indicated a liking for other epic movies such as “Raiders of the Lost Ark” or “2001 Space Odyssey”.

Such systems fall into two broad categories, implicit recommenders and explicit recommenders. Implicit recommenders generate recommendations based on data derived from the past history of preferences of the viewer/consumer, in a non-obtrusive manner. In the context of television viewing, a viewer profile may be generated using a conventional implicit television program recommender. The implicit viewer profile is derived from a viewing history, indicating whether a given viewer liked or disliked each program.

Explicit recommenders, on the other hand, explicitly question viewers about their preferences, such as title, genre, actors, channel and date/time, in a programming context, to derive viewer profiles and generate recommendations. The explicit viewer profile is generated from a viewer survey that provides a rating for each program attribute, for example, on a numerical scale that is mapped to various levels of interest between “hates” and “loves,” indicating whether a given viewer liked or disliked each program.

While both the implicit and explicit recommendation systems, discussed above, assist users in identifying items of interest, they suffer from a number of limitations. For example, to be comprehensive, explicit recommendation tools are very tedious to initialize, requiring each new user to respond to a very detailed survey specifying their preferences at a coarse level of granularity. While implicit recommendation systems derive profiles unobtrusively, for example, by observing viewing behaviors, they require a long time to become accurate. In addition, such implicit recommendation systems require at least a minimal amount of viewing/purchasing history to begin making any recommendations. Thus, such implicit systems are unable to make any recommendations when the recommendation system is initially deployed.

Other recommender systems, based on collaborative filtering techniques, such as the system used by Amazon.com to recommend music and books to users, are based on the premise that a user will have similar musical or literary tastes to other users with whom they share common purchases. However, collaborative systems such as Amazon's are often swayed into recommending items which are tangential to the user's tastes. This “off the mark” effect is usually due to a large group of people whose tastes are generally not the same as the user's, except in a small overlapping area. Another pitfall of Amazon's system is an inability to recognize purchased items as not being representative of the purchaser. Gifts bought for others may incorrectly “trick” the collaborative system into misrepresenting a user's tastes. Lastly, while purchases are a good indication of a user's tastes, there is no way in Amazon's system to explore a person's preferences in areas which they have not made a prior purchase. Consumers often like music and/or books which they do not buy, and this preference data is not captured by collaborative filtering.

A need therefore exists for a method and apparatus that can recommend items unobtrusively before a sufficient personalized viewing or purchase history is available. A corollary to the aforementioned need is a need for a method and apparatus for generating program or purchase recommendations for a given user based on the profiles of third parties.

The present invention is directed to various embodiments for recommending items of interest to an advisee, such as television program recommendations, based on other user's viewing preferences.

Current recommendation systems recommend programs, purchases, etc. to advisees based on what other users in a geographical area have watched or purchased without taking into account the demographic data of the other users which leads to inaccurate recommendations. In accordance with the principles of the invention, a more accurate measure of an advisee's viewing or purchasing preferences may be obtained by taking into account such demographic data. Accordingly, in contrast to the state of the art, the other user's, whose preferences are used to make recommendations to the advisee, have at least one demographic in common with the advisee. The at least one demographic may be any demographic, for example, such as, age, income, gender, occupation, education and combinations thereof.

According to one aspect of the invention, recommendations are generated based on an advisee's viewing or purchasing preferences before a viewing or purchase history of the new user is available. It is noted, however, that the invention is applicable to established users who have established provide a viewing or purchase history with the system.

In accordance with one embodiment, a method for recommending items, includes the acts of: receiving a recommendation request from an advisee for a recommendation of one or more items; filtering a general population of users to identify a sub-population of users who share at least one demographic in common with the advisee; computing a degree of closeness measure between preference data associated with each user in the sub-population and one of preference and profile data associated with the advisee; selecting the preference data associated with N users from said sub-population having the lowest computed degree of closeness measure with the advisee, where N is a positive integer value, equal to or greater than 1; and using the selected preference data to recommend the items to the advisee.

In accordance with another embodiment, a method for recommending items, includes the acts of: receiving a recommendation request from an advisee for a recommendation of one or more items; filtering a general population of users to identify a sub-population of users who share at least one demographic in common with the advisee; computing a degree of closeness measure between profile data associated with each user in the sub-population and one of preference and profile data associated with the advisee; selecting the preference data associated with N users from said sub-population having the lowest computed degree of closeness measure with the advisee, where N is a positive integer value, equal to or greater than 1; and using the selected profile data to recommend the items to the advisee.

In accordance with a still further embodiment, a method for recommending items, includes the acts of: receiving a recommendation request from an advisee for a recommendation of one or more items; filtering a general population of users to identify a sub-population of users who share at least one demographic in common with said advisee; generating one or more mean profiles from preference data associated with said sub-population of users; computing a distance measure between the one or more mean profiles and profile data associated with said advisee; selecting N mean profiles whose computed distance measure is determined to be lowest, where N is a positive integer value, equal to or greater than 1; and using the N selected mean profiles to recommend said items to the advisee.

In another aspect, the invention relates to an apparatus for recommending items which include a processor; a memory connected to the processor and storing computer executable instructions therein; wherein the processor, in response to execution of the instructions: receives a recommendation request from an advisee for a recommendation of one or more items; filters a general population of users to identify a sub-population of users who share at least one demographic in common with said advisee; computes a degree of closeness measure between preference data associated with each of said sub-population of users and one of preference and profile data associated with said advisee; selects at least the preference data associated with the user from said sub-population whose computed degree of closeness measure is determined to be highest; and uses the selected preference data to recommend said one or more items to the advisee.

In yet another aspect, the invention relates to an article of manufacture, according to one embodiment, having embodied thereon computer-readable program means for receiving a recommendation request from an advisee for a recommendation of one or more items; computer readable program means for filtering a general population of users to identify a sub-population of users who share at least one demographic in common with the advisee; computer readable program means for computing a degree of closeness measure between preference data associated with each user in the sub-population and one of preference and profile data associated with the advisee; computer readable program means for selecting the preference data associated with N users from said sub-population having the lowest computed degree of closeness measure with the advisee, where N is a positive integer value, equal to or greater than 1; and computer readable program means for using the selected preference data to recommend the items to the advisee.

This invention is pointed out with particularity in the appended claims. The above and further advantages of this invention may be better understood by referring to the following description taken in conjunction with the accompanying drawings, in which:

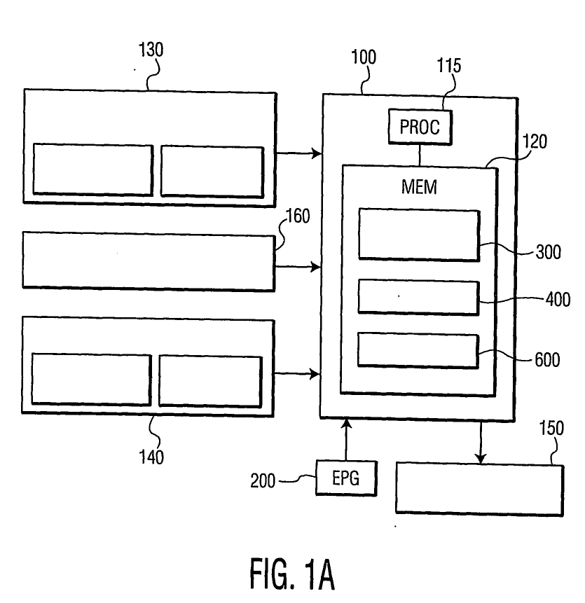

FIGS. 1a, 1b and 1c are schematic block diagrams of a television program recommender in accordance with various embodiments of the apparatus of the present invention;

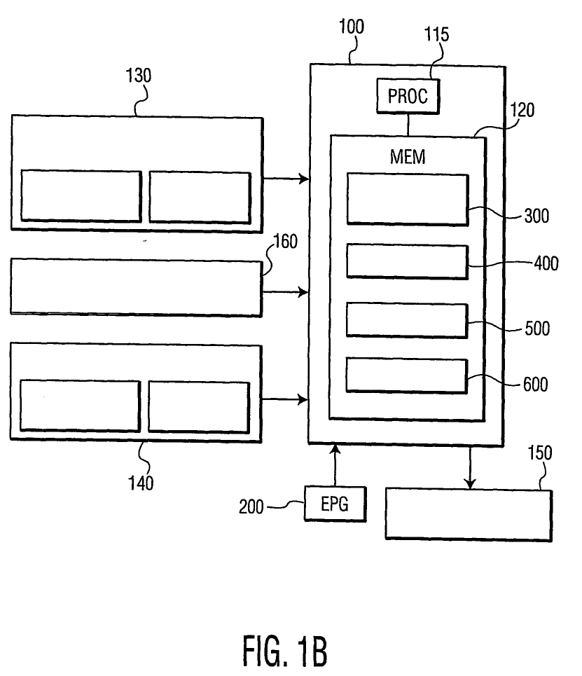

FIG. 2 is a sample table from an exemplary program database of FIG. 1;

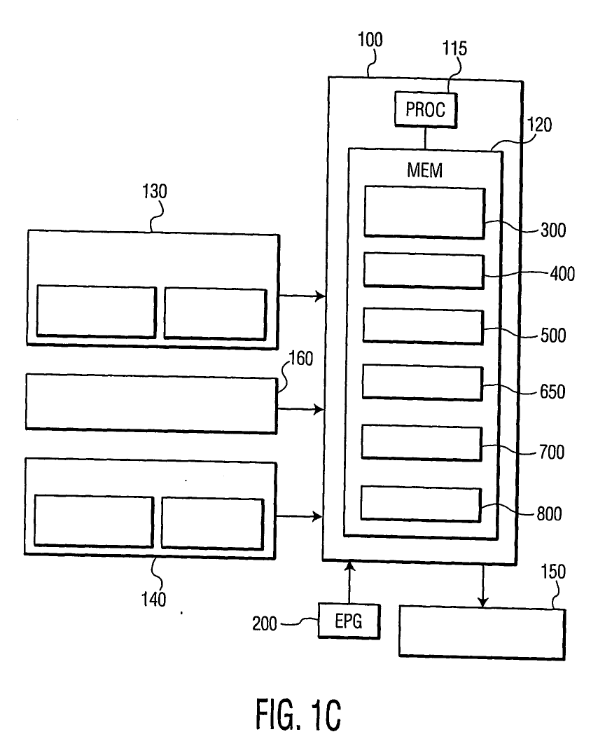

FIG. 3 is a flowchart describing one embodiment of the method of the invention;

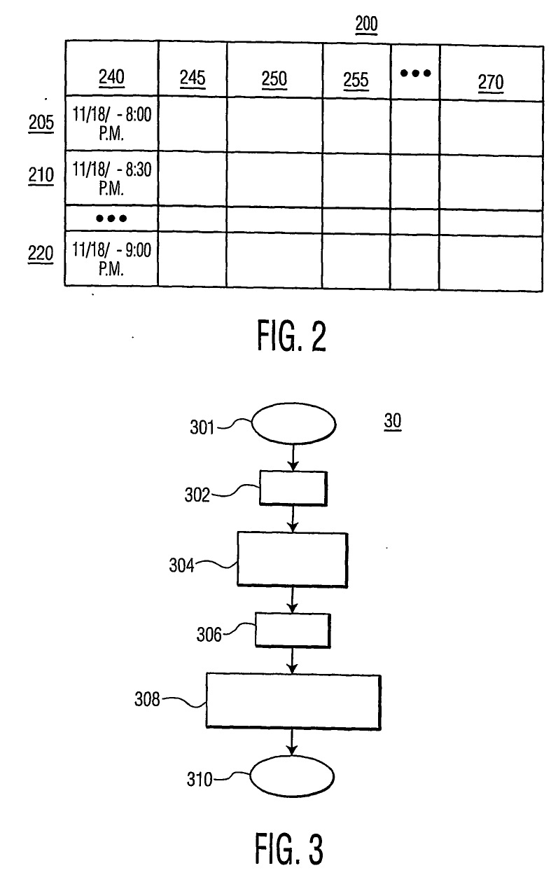

FIG. 4 illustrates a sample table from a viewing history of a third party viewer used by a recommender system of the invention;

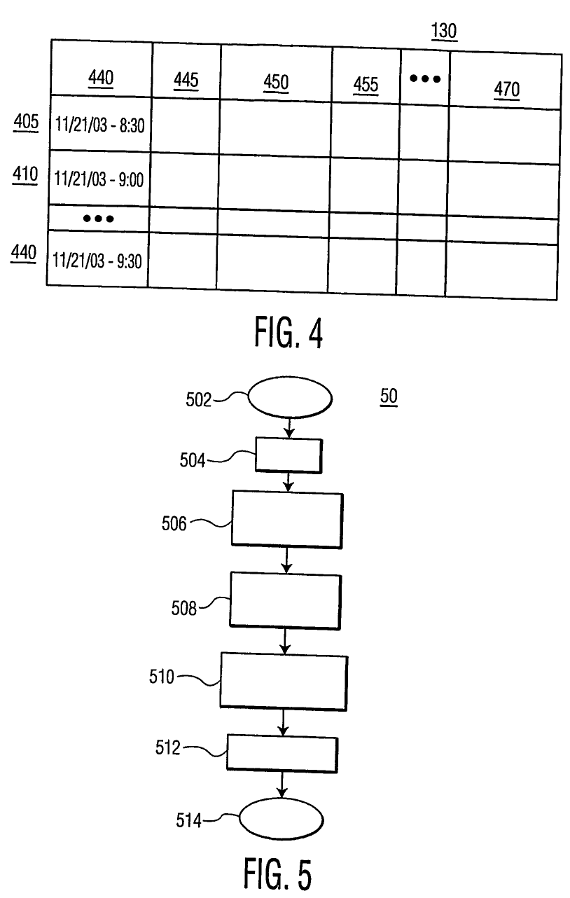

FIG. 5 is a flowchart describing another embodiment of the method of the invention;

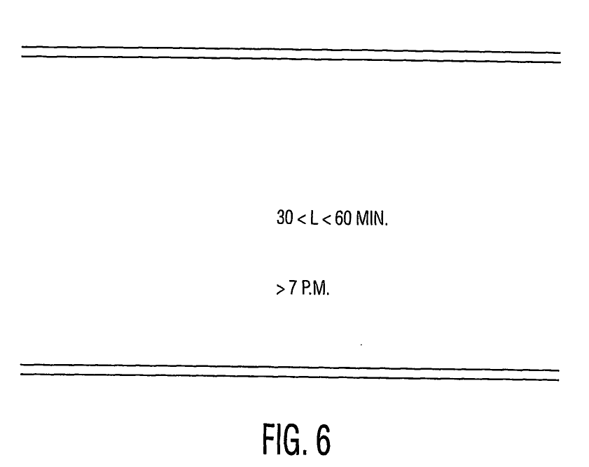

FIG. 6 illustrates a sample table from a profile of a third party viewer used by a recommender system of the invention; and

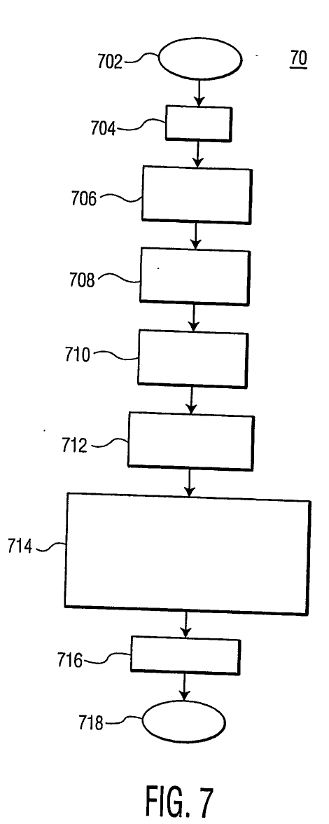

FIG. 7 is a flowchart describing yet still another embodiment of the method of the invention.

Methods and systems for recommending items of interest to a user, such as television program and purchasing recommendations, based on other user's viewing/purchasing profiles/preferences is disclosed. The following description is presented to enable any person skilled in the art to make and use the invention. For purposes of explanation, specific nomenclature is set forth to provide a thorough understanding of the present invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

The present invention can be realized in hardware, software, or a combination of hardware and software. Any kind of computer system or other apparatus adapted for carrying out the methods described herein. A typical combination of hardware and software could be a general purpose computer system with a computer program that, when being loaded and executed, controls the computer system such that it carries out the methods described herein The present invention can also be embedded in a computer program product, which comprises all the features enabling the implementation of the methods described herein, and which, when being loaded in a computer system, is able to carry out these methods.

The various features and methods of the invention will now be described in the context of a television viewing recommendation service, including three specific implementations thereof, that is used to recommend television viewing preferences. As will be recognized to those skilled in the art, the disclosed methods can also be used to recommend other types of items, including non-physical items. By way of example and not limitation, the disclosed methods can also be used to recommend authors, artists, categories or groups of titles, Web sites, chat groups, movies, television shows, downloadable content, restaurants, and other users.

For convenience, the remainder of this specification will use the terms “user”, “advisee” and “new user” to refer to single users of the system, as well as “composite users.”

FIG. 1a illustrates a television programming recommender 100 in accordance with one embodiment of the present invention. As shown in FIG. 1, the exemplary television programming recommender 100 evaluates programs in a program database 200, discussed below in conjunction with FIG. 2, to identify programs of interest to a particular viewer. The set of recommended programs can be presented to the viewer, for example, using a set-top terminal/television (not shown) using well-known on-screen presentation techniques. While the present invention is illustrated herein in the context of television programming recommendations, the present invention can be applied to any automatically generated recommendations that are based on an evaluation of user behavior, such as a viewing history or a purchase history. According to one feature of the present invention, the television programming recommender 100 can generate television program recommendations before a viewing or purchasing history 140 of a new user is available, such as when a user first obtains the television programming recommender 100.

The television program recommender 100 may be embodied as any computing device, such as a personal computer or workstation, that contains a processor 115, such as a central processing unit (CPU) 115, and memory 120, such as RAM and/or ROM. The television program recommender 100 may also be embodied as an application specific integrated circuit (ASIC), for example, in a set-top terminal or display (not shown). In addition, the television programming recommender 100 may be embodied as any available television program recommender, such as the Tivo™ system, commercially available from Tivo, Inc., of Sunnyvale, Calif., or the television program recommenders described in U.S. patent application Ser. No. 09/466,406, filed Dec. 17, 1999, entitled “Method and Apparatus for Recommending Television Programming Using Decision Trees,” U.S. patent application Ser. No. 09/498,271, filed Feb. 4, 2000, entitled “Bayesian TV Show Recommender,” and U.S. patent application Ser. No. 09/627,139, filed Jul. 27, 2000, entitled “Three-Way Media Recommendation Method and System,” or any combination thereof, each incorporated herein by reference, as modified herein to carry out the features and functions of the present invention.

### A. FIRST EMBODIMENT

The first embodiment utilizes principles of collaborative filtering. There are several patents in regard to methods for collaborative filtering. U.S. Pat. Nos. 5,790,426, 5,867,799 and 6,092,049 present methods and apparatus for recommending items on the basis of ratings given to an item by the user.

As shown in FIG. 1a, and discussed further below in conjunction with FIGS. 3 and 4, the television programming recommender 100, in one embodiment, includes a program database 200, a demographic filter routine 300, and a viewer preference process 400.

Generally, the program database 200, may be embodied as a well-known electronic program guide and records data for each program that is available in a given time interval. The demographic filter routine 300 processes a general population of third party users to identify those third party users from among the general population who share at least one demographic with an advisee, referred to herein as a ‘sub-population’ of third-party users. The viewer preference process 400 identifies viewing preferences for each third party user in the demographically filtered sub-population. The degree of closeness routine 600 evaluates the closeness of each third party viewer's preference data with preference data provided by the advisee.

FIG. 2 is a sample table from the program database (EPG) 200 of FIG. 1. As previously indicated, the program database 200 records data for each program that is available in a given time interval. As shown in FIG. 2, the program database 200 contains a plurality of records, such as records 205 through 220, each associated with a given program. For each television program, the program database 200 indicates the date/time and channel associated with the television program in fields 240 and 245, respectively. In addition, the title, genre and actors for each program are identified in fields 250, 255 and 270, respectively. Additional well-known features (not shown), such as duration and description of the program, can also be included in the program database 200.

Referring now to FIG. 3, a first exemplary method 30 for recommending items of interest to an advisee, such as television program recommendations, based on third party user's viewing preferences are shown in the form of a flowchart. In accordance with the principles of the invention, the third party users of interest are those users who share one or more demographics in common with the advisee.

At act 301, the process begins.

At act 302, the demographic filter routine 300, shown in FIG. 1a, filters the larger population of third party viewers to identify and select a sub-population of third party viewers who share at least one demographic in common with the advisee. The at least one demographic may be any demographic, for example, such as, age, interests, income, gender, occupation and education or combinations thereof. As one example, if it is known that the advisee is male then this demographic may be selected as a ‘filter’ for use by the demographic filter routine 300 to filter the general population of users to identify those third party viewers in the sub-population who are male.

At act 304, a preference process routine 400 is called by the demographic filter routine 300 to generate third party viewer preference data 140 for each viewer or member in the identified (at act 302) demographically compatible sub-population of third-party users.

FIG. 4 illustrates exemplary third party viewer preference data 130. The third party viewer preference data 400 shown represents data that is typically generated from a viewer survey that provides a rating for each program feature. As shown in FIG. 4, the third party viewer preference data 400 contains a plurality of records, such as records 405 through 420, each associated with a given program. For each television program, the third party viewer preference data 400 indicates the date/time and channel associated with the television program in fields 440 and 445, respectively. In addition, the title, genre and actors for each program are identified in fields 450, 455 and 470, respectively. Additional well-known features (not shown), such as duration and description of the program, can also be included in the third party viewer preference data 400.

At act 306, a degree of closeness routine 600 is called by the preference process routine 400 to evaluate the closeness of each third party viewer's preference data 130 with the preference data 140 provided by the advisee. That is, the viewer preference data obtained at act 304 is compared with the viewer preference data of the advisee. It is noted that, in the case where an advisee has pre-existing profile data available for use, the profile data will substitute for the preference data at this step. Further, if the advisee establishes a profile 140 with the system over a period of time, the profile 140 may substitute for the advisee's preference data 140 at this step.

At act 308, the preference data 130 of the third party viewers in the sub-population determined to be closest to the advisee's preference data 140 will be used to make program recommendations 150 to the advisee. In one embodiment, the closest N third party viewer's whose preference data is determined to be closest to the advisee's provided preference data 140 maybe used to make program recommendations 150 to the advisee. For example, act 308 identifies which third party viewers from the sub-population have minimum distance with the advisee, as compared at act 306, and uses the identified third party viewers to recommend viewing preferences to the advisee. The variable N may be provided as an input parameter or may be provided as a system default value (e.g., N=1 or N=2 or N=3, etc.)

At act 310, the process terminates.

### SECOND EMBODIMENT

As shown in FIG. 1b, and discussed further below in conjunction with FIGS. 5 and 6, the television programming recommender 100 includes a program database 200, a demographic filter routine 300, a viewer preference process 400, a profile process 500, and a degree of closeness routine 600.

Referring now to FIG. 5, a second exemplary method 50 for recommending items of interest to an advisee, such as television program recommendations, based on third party viewer's viewing profiles is shown in the form of a flowchart. In accordance with the principles of the invention, the third party viewer's share one or more demographic characteristics in common with the advisee.

At act 502, the process begins.

At act 504, the demographic filter routine 300, shown in FIG. 1b, filters the larger population of third party viewers to identify and select a sub-population of third party viewers who share one or more pre-selected demographic characteristics in common with an advisee. The demographic may be any demographic, such as, for example, age, interests, income, gender, occupation and education or combinations thereof.

At act 506, a viewer preference process 400 is called by the demographic filter routine 300 to generate third party viewer preference data 140 for each viewer in the identified (at act 504) demographically compatible sub-population.

At act 508, a profile process 500 is called by the viewer process 400 to generate third party viewer profile data 150 for each viewer in the identified (at act 504) demographically compatible sub-population. The profile process 500 (implicit or explicit) may be performed in accordance with Ser. No 09/466,406 entitled “Method and Apparatus for Recommending Television Programming using Decision Trees” filed on Dec. 17, 1999, which is hereby incorporated by reference in its entirety.

FIG. 6 illustrates exemplary third party viewer profile data 60. The third party viewer profile data shown represents data that is typically constructed from viewer preference data, such as that shown in FIG. 4.

At act 510, a degree of closeness routine 600 is called by the profile process 500 to evaluate the closeness of each third party viewer's profile data 140 with the preference data provided by the advisee. For example, act 510 identifies which third party viewers from the sub-population have minimum profile distance with the advisee's preference data. It is noted that, in the case where a new user has pre-existing profile data available for use, the profile data will substitute for the preference data at this step.

At act 512, the profile data 160 of one or more of the third party viewers in the sub-population identified or determined (at act 510) to be closest to the advisee's provided preference data 140 will be used to make program recommendations 150 to the advisee. In one embodiment, the closest N third party viewer's whose profile data is determined to be closest to the advisee's provided preference data 140 (or profile data 160 where available) may be used to make program recommendations 150 to the advisee. The variable N may be provided as an input parameter or may be provided as a system default value (e.g., N=1 or N=2 or N=3, etc.)

At act 514, the process terminates.

### THIRD EMBODIMENT

As shown in FIG. 1c, and discussed further below in conjunction with FIG. 6 the television programming recommender 100 includes a program database 200, a geographical filter routine 300, a preference process routine 400, a profile process routine 500, a clustering routine 650, a mean profile creation routine 700 and a distance computation routine 800.

Referring now to FIG. 7, a third exemplary method 70 for recommending items of interest to an advisee, such as television program recommendations, based on third party viewer's viewing profiles shown in the form of a flowchart. In accordance with the principles of the invention, the third party viewer's share one or more demographics in common with the advisee.

At act 702, the process begins.

At act 704, the demographic filter routine 300 filters the larger population of third party viewers to identify and select a sub-population of third party viewers who share one or more demographics in common with the advisee. The demographic may be any demographic, such as, for example, age, interests, income, gender, occupation and education or combinations thereof.

At act 706, a preference process routine 400 is called by the demographic filter routine 300 to generate third party viewer preference data 140 for each viewer in the identified (at act 704) demographically compatible sub-population.

At act 708, a profile process routine 500 is called by the preference process routine 400 to generate third party viewer profile data 150 from the viewer preference data for each viewer in the identified demographically compatible sub-population.

At act 710, a clustering routine 650 is called by the profile process routine 500 to generate one or more clusters 170 from the third party viewer profile data identified at act 708. Any number of methods may be used to perform clustering. The act of clustering may be performed using any clustering method known in the art, such as K-means. One clustering method which may be used is described in Ser. No. 10/014192 entitled “Method and Apparatus For Generating A Stereotypical Profile For Recommending Items of Interest Using Item-based Clustering”, filed on Nov. 11, 2001, which is hereby incorporated by reference in its entirety.

At act 712, a mean profile creation routine 700 is called by the clustering routine 650 to generate one or more mean profiles 180 from or corresponding to the clusters created at act 710.

At act 714, a distance computation routine 800 is called by the mean profile creation routine to evaluate the closeness of the one or more mean profiles with the preference data 140 provided by the advisee. It is noted that, in the case where the advisee has pre-existing profile data 160 available for use, the profile data will be used in lieu of the advisee's provided preference data 140 at this step.

At act 716, those mean profiles from among the one or more mean profiles which are determined to be closest to the advisee's provided preference data 140 will be used to make program recommendations 150 to the advisee. In one embodiment, the closest N third party viewer's whose preference data is determined to be closest to the advisee's provided preference data 140 (or profile data 160 where available) may be used to make program recommendations 150 to the advisee. The variable N may be provided as an input parameter or may be provided as a system default value (e.g., N=1 or N=2 or N=3, etc.)

At act 718, the process terminates.

The foregoing is to be constructed as only being an illustrative embodiment of this invention. Persons skilled in the art can easily conceive of alternative arrangements providing a functionality similar to this embodiment without any deviation from the fundamental principles or the scope of this invention.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means[ may be represented by the same item or hardware or software implemented structure or function; and
e) each of the disclosed elements may be comprised of hardware portions (e.g., discrete electronic circuitry), software portions (e.g., computer programming), or any combination thereof.

1. A method for recommending items (150), comprising the acts of:
(a) receiving a recommendation request from an advisee;
(b) filtering a general population of users (300) to identify a sub-population of users who share at least one demographic in common with said advisee;
(c) computing a degree of closeness measure (600) between preference data (130) associated with each user in the sub-population and one of preference (140) and profile data (160) associated with said advisee;
(d) selecting the preference data associated with N users from said sub-population having the lowest computed degree of closeness measure (600) with the advisee, where N is a positive integer value, equal to or greater than 1; and
(e) using the preference data selected at said step (d) to recommend said items (150) to the advisee.

2. The method of claim 1, wherein N is provided as one of a system default value and as a user provided input value.

3. The method of claim 1, further comprising the act of accumulating preference data, prior to said act (c), wherein said preference data is accumulated from one or more viewer surveys that provide a rating of item features.

4. The method of claim 1, wherein said items are television programs obtained from an electronic program guide.

5. The method of claim 1, wherein said preference data is provided by one of an implicit and explicit program recommender.

6. The method of claim 1, wherein said preference data is provided by a collaborative program recommender.

7. The method of claim 1, wherein the at least one demographic is provided as one of an input parameter and a system default value.

8. A method for recommending items (150), comprising the acts of:
(a) receiving a recommendation request from an advisee;
(b) filtering a general population of users (300) to identify a sub-population of users who share at least one demographic in common with said advisee;
(c) computing a degree of closeness measure (600) between profile data associated with each user in said sub-population and one of preference (140) and profile data (160) associated with said advisee;
(d) selecting the profile data associated with N users from said sub-population whose computed degree of closeness measure is lowest, where N is a positive integer value, equal to or greater than 1; and
(e) using the profile data selected at said step (d) to recommend said items (150) to the advisee.

9. The method of claim 8, prior to said act (c), further comprising the acts of:
generating preference data (130) for said sub-population of users from one or more viewer surveys that provide a rating for program features; and
generating profile data (160) from said generated preference data (130).

10. The method of claim 8, wherein said list of one or more items are programs obtained from an electronic program guide.

11. The method of claim 8, wherein said preference data is provided by one of an implicit and explicit program recommender.

12. The method of claim 8, wherein said preference data is provided by a collaborative program recommender.

13. The method of claim 8, wherein the at least one demographic is provided as one of and input parameter and a system default value.

14. A method for recommending items (150), comprising the acts of:
(a) receiving a recommendation request from an advisee;
(b) filtering a general population of users (300) to identify a sub-population of users who share at least one demographic in common with said advisee;
(c) generating mean profiles (700) from preference data associated with said sub-population of users;
(d) computing a distance measure (800) between the N mean profiles and profile data associated with said advisee;
(e) selecting N mean profiles whose computed distance measure (800) is determined to be lowest, where N is a positive integer value, equal to or greater than 1; and
(f) using the N selected mean profiles to recommend said items (150) to the advisee.

15. The method of claim 14, wherein the act of generating mean profiles further comprises the acts of:
accumulating preference data (130) for said sub-population of users from one or more viewer surveys that provide a rating for program features; and
generating profile data (500) from said accumulated preference data;
generating at least one cluster (650) from said preference data; and
generating a mean profile corresponding to said at said at least one cluster.

16. The method of claim 14, wherein said of one or more items are television programs obtained from an electronic program guide.

17. The method of claim 14, wherein said preference data is provided by one of an implicit and explicit program recommender.

18. The method of claim 14, wherein the at least one demographic is provided as one of an input parameter and a default value.

19. A computer implemented apparatus for recommending items (150), the apparatus comprising:
a processor (115);
a memory (120) connected to the processor (1 15) and storing computer executable instructions therein;
wherein the processor (115), in response to execution of the instructions:
receives a recommendation request from an advisee;
filters a general population of users (300) to identify a sub-population of users who share at least one demographic in common with said advisee;
computes a degree of closeness measure (600) between preference data (130) associated with each user in the sub-population and one of preference (140) and profile data (160) associated with said advisee;
selects the preference data associated with N users from said sub-population having the lowest computed degree of closeness measure with the advisee, where N is a positive integer value, equal to or greater than 1; and
uses the selected preference data to recommend said items (150) to the advisee.

20. A computer implemented apparatus for recommending items (150), the apparatus comprising:
a processor (115);
a memory (120) connected to the processor (115) and storing computer executable instructions therein;
wherein the processor (115), in response to execution of the instructions:
receives a recommendation request from an advisee;
filters a general population of users (300) to identify a sub-population of users who share at least one demographic in common with said advisee;
computes a degree of closeness measure (600) between profile data associated with each user in said sub-population and one of preference (140) and profile data (160) associated with said advisee;
selects the profile data associated with N users whose computed degree of closeness measure is lowest, where N is a positive integer value, equal to or greater than 1; and
uses the selected profile data to recommend said items (150) to the advisee.

21. A computer implemented apparatus for recommending items (150), the apparatus comprising:
a processor (115);
a memory (120) connected to the processor (115) and storing computer executable instructions therein;
wherein the processor (115), in response to execution of the instructions:
receives a recommendation request from an advisee;
filters a general population of users (300) to identify a sub-population of users who share at least one demographic in common with said advisee;
generates mean profiles from preference data associated with said sub-population of users;
computes a distance measure between the N mean profiles and profile data associated with said advisee;
selects N mean profiles whose computed distance measure is determined to be lowest; and
uses the N selected mean profiles to recommend said items (150) to the advisee.

22. An article of manufacture for recommending items (150), comprising: a computer readable medium having computer readable code means embodied thereon, said computer readable program code means comprising:
an act of receiving a recommendation request from an advisee;
an act of filtering a general population of users (300) to identify a sub-population of users who share at least one demographic in common with said advisee;
an act of computing a degree of closeness measure (600) between preference data (130) associated with each user in the sub-population and one of preference (140) and profile data (160) associated with said advisee;
an act of selecting the preference data associated with N users from said sub-population having the lowest computed degree of closeness measure with the advisee, where N is a positive integer value, equal to or greater than 1; and
an act of using the selected preference data) to recommend said items to the advisee.

23. An article of manufacture for recommending items (150), comprising: a computer readable medium having computer readable code means embodied thereon, said computer readable program code means comprising:
an act of receiving a recommendation request from an advisee for a recommendation of said items;
an act of filtering a general population of users (300) to identify a sub-population of users who share at least one demographic in common with said advisee;
an act of computing a degree of closeness measure between profile data associated with each user in said sub-population and one of preference (140) and profile data (160) associated with said advisee;
an act of selecting the profile data associated with N users whose computed degree of closeness measure is lowest, where N is a positive integer value, equal to or greater than 1; and
an act of using the selected profile data to recommend said items to the advisee.

24. An article of manufacture for recommending items (150), comprising: a computer readable medium having computer readable code means embodied thereon, said computer readable program code means comprising:
an act of receiving a recommendation request from an advisee;
an act of filtering a general population of users (300) to identify a sub-population of users who share at least one demographic in common with said advisee;
an act of generating mean profiles (700) from preference data associated with said sub-population of users;
an act of computing a distance measure (800) between the mean profiles and profile data associated with said advisee;
an act of selecting N mean profiles whose computed distance measure is determined to be lowest, where N is a positive integer value, equal to or greater than 1; and
an act of using the N selected mean profiles to recommend said items (150) to the advisee.
